(19) United States
(12) Patent Application Publication
(10) Pub. No.: US 2019/0052815 A1
(43) Pub. Date: Feb. 14, 2019

(54) DUAL-CAMERA IMAGE PICK-UP APPARATUS AND IMAGE CAPTURING METHOD THEREOF

(71) Applicant: Altek Semiconductor Corp., Hsinchu City (TW)

(72) Inventor: Chun-Chang Wang, Hsinchu City (TW)

(73) Assignee: Altek Semiconductor Corp., Hsinchu City (TW)

(21) Appl. No.: 15/814,403

(22) Filed: Nov. 16, 2017

(30) Foreign Application Priority Data
Aug. 10, 2017 (TW) 106127007

(51) Int. Cl. H04N 5/247; H04N 5/907; H04N 5/04

(52) U.S. Cl. CPC H04N 5/247; H04N 5/23212; H04N 5/04; H04N 5/907

(57) ABSTRACT

A dual-camera image pick-up apparatus and an imaging capturing method thereof are provided. The dual-camera image pick-up apparatus includes a first camera, a second camera, a first buffer, a second buffer and an image signal processor (ISP). The second buffer is coupled to the second camera and configured to receive and temporarily store a raw file captured by the second camera. The ISP is coupled to the first camera, the second camera, the first buffer and the second buffer, and configured to respectively control the first camera and the second camera to capture image signals and output a first raw file and a second raw file, process the image signals in the first raw file to output a first image to the first buffer, and afterward receive the temporarily stored second raw file from the second buffer, and process the image signals in the second raw file to output a second image to the first buffer.

### CROSS-REFERENCE TO RELATED APPLICATION

This application claims the priority benefit of Taiwan application serial no. 106127007, filed on Aug. 10, 2017. The entirety of the above-mentioned patent application is hereby incorporated by reference herein and made a part of this specification.

### BACKGROUND OF THE INVENTION

### Field of the Invention

The invention relates to an image pick-up apparatus and a method thereof, and particularly relates to a dual-camera image pick-up apparatus and an image capturing method thereof.

### Description of Related Art

Along with quick development of image capturing techniques, pixels of digital camera are greatly increased, though a camera size is relatively decreased, so that the digital cameras are adapted to be equipped on portable electronic devices such as mobile phones, tablet personal computers (PC), etc., to facilitate users to capture images at anytime, anywhere. In order to cope with market competition and meet the diverse needs of the consumers in photography, various manufacturers are committed to improve camera functions to enhance competitiveness of the products. Besides the originally equipped camera, in recent years, many devices are additionally equipped with another camera to construct dual cameras with the original camera to capture three-dimensional (3D) images. In detail, the dual cameras may be synchronously triggered to capture images of a same region with different viewing angles, and the images may simulate the images viewed by human left and right eyes, and through alternating display of a display, a viewer may have a stereoscopic feel.

In order to process raw files captured by the two cameras in real-time, a conventional dual-camera image pick-up apparatus is equipped with a dual-channel image signal processor (ISP), and each ISP is in charge of image capturing of one camera, so as to simultaneously capture dual-camera images exposed at the same time. However, since the dual cameras require the support of the dual-channel ISP, a price of the processing chip thereof (supporting the dual-channel) is higher than that of a processing chip supporting a single channel.

### SUMMARY OF THE INVENTION

The invention is directed to dual-camera image pick-up apparatus and an image capturing method thereof, which support processing of raw files captured by dual cameras in case that a single image signal processor is used.

The invention provides a dual-camera image pick-up apparatus including a first camera, a second camera, a first buffer, a second buffer and an image signal processor. The second buffer is coupled to the second camera and is configured to receive and temporarily store a raw file output by the second camera. The image signal processor is coupled to the first camera, the second camera, the first buffer and the second buffer, and is configured to respectively control the first camera and the second camera to capture image signals to output a first raw file and a second raw file, process the image signals in the first raw file to output a first image to the first buffer, and receive the temporarily stored second raw file from the second buffer after outputting the first image, and process the image signals in the second raw file to output a second image to the first buffer.

In an embodiment of the invention, the first camera outputs the first raw file to the image signal processor through a first camera interface, and the second camera outputs the second raw file to the second buffer through a second camera interface.

In an embodiment of the invention, the dual-camera image pick-up apparatus further includes a processor, which is configured to receive the first image and the second image from the first buffer to execute a dual-camera application.

The invention provides an image capturing method adapted to a dual-camera image pick-up apparatus including a first camera, a second camera, a first buffer, a second buffer and an image signal processor. The image capturing method includes: respectively controlling the first camera and the second camera to capture image signals to output a first raw file and a second raw file by the image signal processor; processing the image signals in the first raw file to output a first image to the first buffer by the image signal processor; after outputting the first image, receiving the temporarily stored second raw file from the second buffer, and processing the image signals in the second raw file to output a second image to the first buffer by the image signal processor.

In an embodiment of the invention, the step of respectively controlling the first camera and the second camera to capture the image signals to output the first raw file and the second raw file by the image signal processor includes outputting the first raw file to the image signal processor by the first camera through a first camera interface, and outputting the second raw file to the second buffer by the second camera through a second camera interface.

In an embodiment of the invention, the image signal processor synchronizes automated pre-processing parameters of the first camera and the second camera to synchronously capture the image signals, where the automated pre-processing parameters include auto focus (AF), auto exposure (AE) and auto white balance (AWB).

In an embodiment of the invention, the dual-camera image pick-up apparatus further includes a processor, and after the image signal processor outputs the second image, the method further includes receiving the first image and the second image by the processor from the first buffer to execute a dual-camera application.

According to the above description, in the dual-camera image pick-up apparatus and the image capturing method thereof, the dual-camera image pick-up apparatus uses the image signal processor to sequentially process the raw files output by the first camera and the second camera and produced by capturing the image signals, where the raw file of the second camera is temporarily stored when the image signals in the raw file of the first camera are processed, and the raw file of the second camera is processed afterwards. In this way, processing of the image signals of the dual cameras is supported in case that the single image signal processor is used.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a dual-camera image pick-up apparatus according to an embodiment of the invention.

FIG. 2 is a flowchart illustrating an image capturing method of a dual-camera image pick-up apparatus according to an embodiment of the invention.

FIG. 3A to FIG. 3C are examples of an image capturing method of a dual-camera image pick-up apparatus according to an embodiment of the invention.

FIG. 4 is a block diagram of a dual-camera image pick-up apparatus according to an embodiment of the invention.

### DESCRIPTION OF EMBODIMENTS

In the invention, by adjusting a photographing process, an image signal processor first processes a raw file output by a primary camera of a dual-camera image pick-up apparatus according to the original photographing process, and now a raw file output by a secondary camera is temporarily stored in a buffer, and after the image signal processor completes processing the raw file of the primary camera, the temporarily stored raw file of the secondary camera is fed back to the image signal processor for processing, and finally a processed dual-camera image is obtained. In this way, processing of the image signals of the dual cameras can be supported in case that the single image signal processor is used.

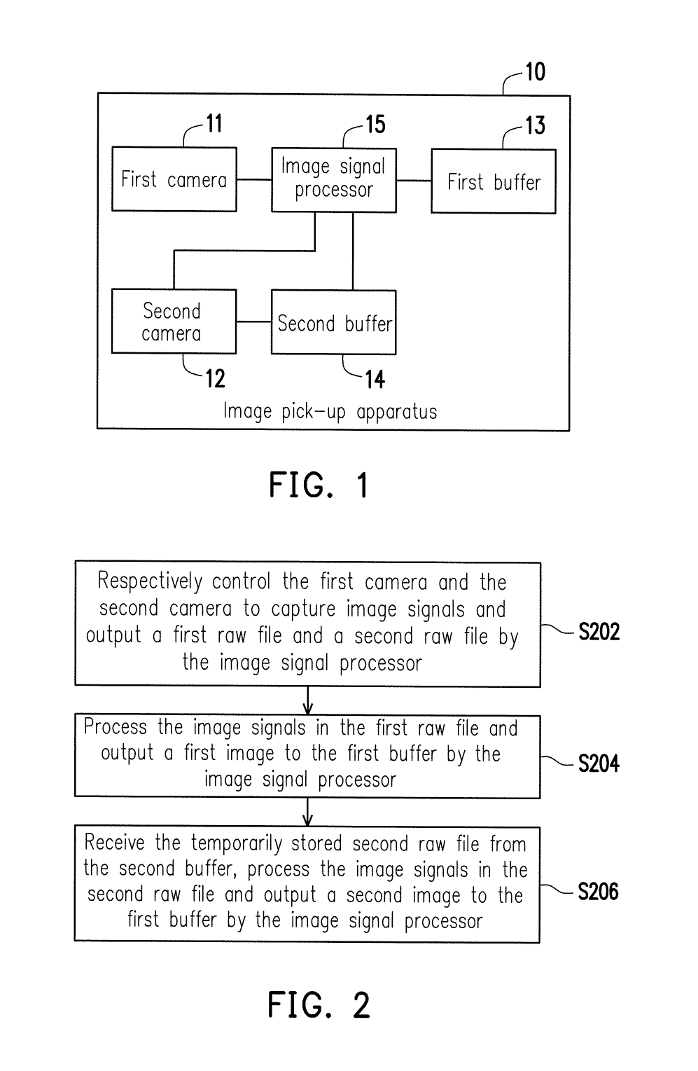

FIG. 1 is a block diagram of a dual-camera image pick-up apparatus according to an embodiment of the invention. Referring to FIG. 1, the dual-camera image pick-up apparatus 10 of the present embodiment is, for example, an electronic device having a camera function such as a mobile phone, a tablet personal computer (PC), a notebook computer, a navigation device, a vehicle driving recorder, a digital camera, a digital video camcorder (DVC), etc. The dual-camera image pick-up apparatus 10 includes a first camera 11, a second camera 12, a first buffer 13, a second buffer 14 and an image signal processor 15, an functions thereof are respectively described below.

The first camera 11 and the second camera 12 respectively includes a lens and an image sensor, where the lens is a combination of a plurality of concave-convex lenses, and is driven by an actuator such as a stepper motor or a voice coil motor to change relative positions between the lenses, so as to change a focal length of the lens, and therefore a shooting object may be imaged on the image sensor. The image sensor is configured with a charge coupled device (CCD), a complementary metal-oxide semiconductor (CMOS) device or other types of photosensing devices, and is adapted to sense an intensity of light entering the lens, so as to capture image signals to produce and output a raw file.

The first buffer 13 and the second buffer 14 are, for example, memories adapted to temporarily store data such as random access memories (RAM), electrically erasable programmable read only memories (EEPROM), or flash memories, or hard disks. In the present embodiment, the first buffer 13 is coupled to the image signal processor 15, and is configured to store images processed by the image signal processor 15, and the second buffer 14 is coupled to the second camera 12, and is configured to temporarily store a raw file output by the second camera 12.

The image signal processor 15 is coupled to the first camera 11, the second camera 12, the first buffer 13 and the second buffer 14, and is configured to control operations of the first camera 11 and the second camera 12. In an embodiment, the image signal processor 15 is configured to perform 3A processing including auto focus (AF), auto exposure (AE) and auto white balance (AWB) on the image signals captured by the first camera 11 or the second camera 12. In other embodiments, the image signal processor 15 may also perform mage pre-processing, for example, brightness value calculation, contrast adjustment, etc., and color correction processing such as image hue and saturation adjustment, etc. on the aforementioned image signals. In the present embodiment, the image signal processor 15 controls the first camera 11 and the second camera 12 to capture the image signals, and performs image processing on the image signals to implement the image capturing method of the dual-camera image pick-up apparatus of the present embodiment.

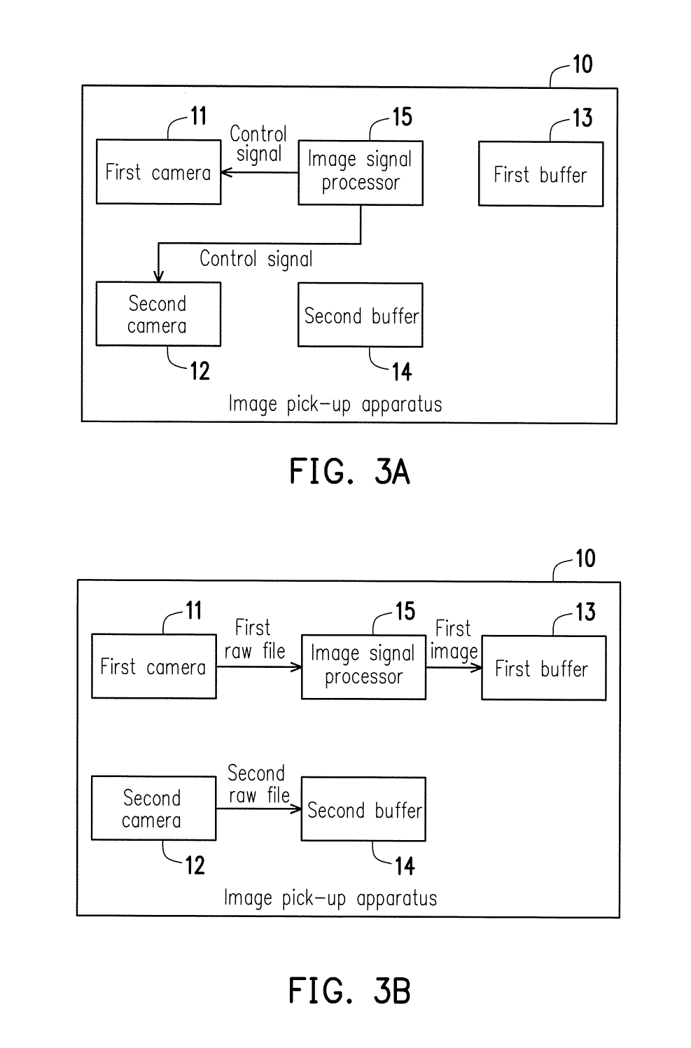

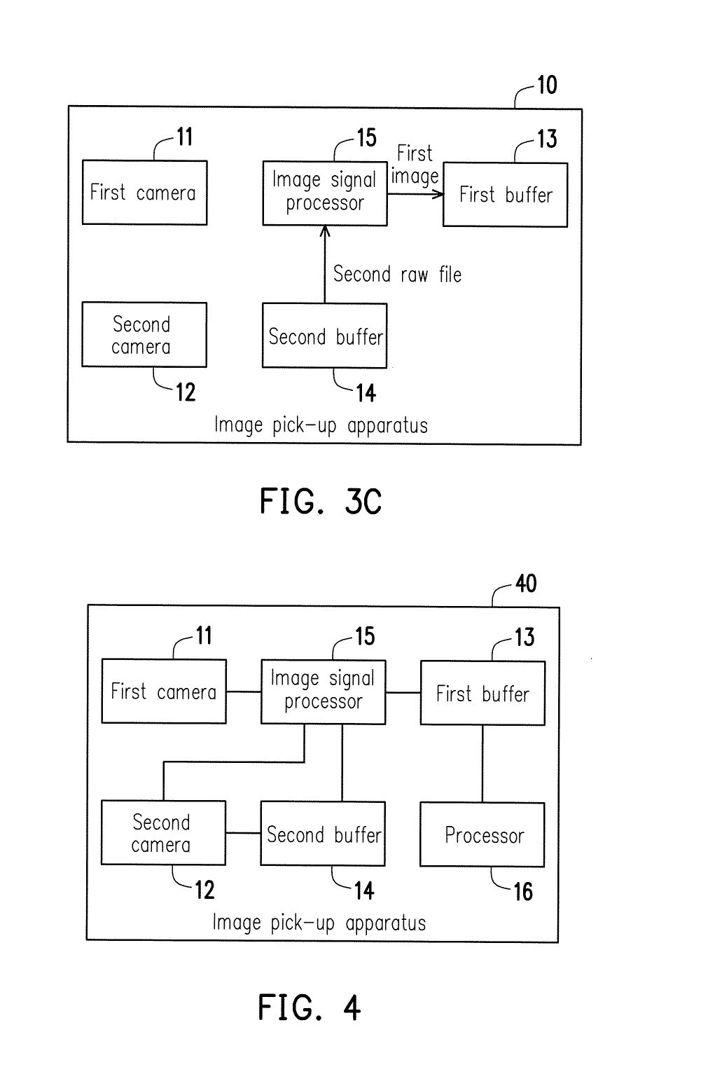

In detail, FIG. 2 is a flowchart illustrating an image capturing method of a dual-camera image pick-up apparatus according to an embodiment of the invention. FIG. 3A to FIG. 3C are examples of the image capturing method of a dual-camera image pick-up apparatus 20 according to an embodiment of the invention, where detailed steps of the image capturing method of the present embodiment are described in detail below with reference of various components of the dual-camera image pick-up apparatus 20 of FIG. 3A to FIG. 3C.

First, as shown in FIG. 3A, the image signal processor 15 respectively sends control signals to the first camera 11 and the second camera 12 to control the first camera 11 and the second camera 12 to respectively image signals to output a first raw file and a second raw file (step S202). The image signal processor 15, for example, synchronizes automated pre-processing parameters of the first camera 11 and the second camera 12 such as auto focus (AF), auto exposure (AE) and auto white balance (AWB), etc., to synchronously capture the image signals and output the first raw file and the second raw file, so as to ensure that the first camera 11 and the second camera 12 synchronously captures the image signals under the same image capturing conditions.

Then, referring to FIG. 3B, the first raw file output by the first camera 11 is, for example, output to the image signal processor 15 through a first camera interface (CAMIF), and the second raw file output by the second camera 12 is, for example, output to the second buffer 14 through a second camera interface. Now, the image signal processor 15 processes the image signals in the first raw file, and outputs a processed first image to the first buffer 13 (step S204).

Then, referring to FIG. 3C, after the image signal processor 15 completes processing the image signals in the first raw file and outputs the processed first image to the first buffer 13, the image signal processor 15 receives the temporarily stored second raw file from the second buffer 14, processes the image signals in the second raw file, and outputs a processed second image to the first buffer 13 (step S206).

According to the above method, the dual-camera image pick-up apparatus may sequentially process the raw files output by the dual cameras to achieve an effect similar to that of a dual-channel image signal processor in case that only a single-channel image signal processor is equipped.

FIG. 4 is a block diagram of a dual-camera image pick-up apparatus according to an embodiment of the invention. Referring to FIG. 4, the dual-camera image pick-up apparatus 40 includes the first camera 11, the second camera 12, the first buffer 13, the second buffer 14, the image signal processor 15 and a processor 16, where the functions of the first camera 11, the second camera 12, the first buffer 13, the second buffer 14 and the image signal processor 15 are the same to that of the same devices of the embodiment of FIG. 1, and detail thereof is not repeated.

Different from the aforementioned embodiment, in the present embodiment, the dual-camera image pick-up apparatus 40 further includes the processor 16 coupled to the first buffer 13. The processor 16 is, for example, a central processing unit (CPU), a microprocessor, a digital signal processor, a programmable controller, an application specific integrated circuits (ASIC) or a programmable logic device (PLD), and is adapted to receive the first image and the second image processed by the image signal processor 15 from the first buffer 13 to execute a dual-camera application. The dual-camera application includes producing a 3D image by using the first image and the second image, and any application using the dual-camera images such as executing focusing, image scaling, depth-of-field calculation, shallow depth-of-field image processing, etc., by using the first image and the second image.

In summary, in the dual-camera image pick-up apparatus and the image capturing method thereof, by changing a photographing process, the raw file output by the secondary camera is first temporarily stored in the buffer memory, and the image signal processor first processes the raw file output by the primary camera, and after the primary camera completes image capturing, and the image signal processor is idle, the raw file of the secondary camera is fed back to the image signal processor for processing, so as to finally obtain the dual-camera image. In this way, the single-channel image signal processor may also support the image signal processing of the dual cameras, and product competitiveness is enhanced.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A dual-camera image pick-up apparatus, comprising:
a first camera;
a second camera;
a first buffer;
a second buffer, coupled to the second camera, and configured to receive and temporarily store a raw file output by the second camera; and
an image signal processor, coupled to the first camera, the second camera, the first buffer and the second buffer, and configured to respectively control the first camera and the second camera to capture image signals to output a first raw file and a second raw file, process the image signals in the first raw file to output a first image to the first buffer, and receive the temporarily stored second raw file from the second buffer after outputting the first image, and process the image signals in the second raw file to output a second image to the first buffer.

2. The dual-camera image pick-up apparatus as claimed in claim 1, wherein the first camera outputs the first raw file to the image signal processor through a first camera interface, and the second camera outputs the second raw file to the second buffer through a second camera interface.

3. The dual-camera image pick-up apparatus as claimed in claim 1, wherein the image signal processor synchronizes automated pre-processing parameters of the first camera and the second camera to synchronously capture the image signals.

4. The dual-camera image pick-up apparatus as claimed in claim 3, wherein the automated pre-processing parameters comprise auto focus, auto exposure and auto white balance.

5. The dual-camera image pick-up apparatus as claimed in claim 1, further comprising:
a processor, configured to receive the first image and the second image from the first buffer to execute a dual-camera application.

6. An image capturing method, adapted to a dual-camera image pick-up apparatus comprising a first camera, a second camera, a first buffer, a second buffer and an image signal processor, the image capturing method comprising:
respectively controlling the first camera and the second camera to capture image signals to output a first raw file and a second raw file by the image signal processor;
processing the image signals in the first raw file to output a first image to the first buffer by the image signal processor; and
after outputting the first image, receiving the temporarily stored second raw file from the second buffer, and processing the image signals in the second raw file to output a second image to the first buffer by the image signal processor.

7. The image capturing method as claimed in claim 6, wherein the step of respectively controlling the first camera and the second camera to capture the image signals to output the first raw file and the second raw file by the image signal processor comprises:
outputting the first raw file to the image signal processor by the first camera through a first camera interface, and outputting the second raw file to the second buffer by the second camera through a second camera interface.

8. The image capturing method as claimed in claim 6, wherein the image signal processor synchronizes automated pre-processing parameters of the first camera and the second camera to synchronously capture the image signals.

9. The image capturing method as claimed in claim 8, wherein the automated pre-processing parameters comprise auto focus, auto exposure and auto white balance.

10. The image capturing method as claimed in claim 6, wherein the dual-camera image pick-up apparatus further comprises a processor, and after the image signal processor outputs the second image, the image capturing method further comprises:
receiving the first image and the second image from the first buffer by the processor to execute a dual-camera application.
